(19) United States
(12) Patent Application Publication
(10) Pub. No.: US 2009/0250276 A1
(43) Pub. Date: Oct. 8, 2009

(54) HYBRID ELECTRIC VEHICLE AND METHODS OF PRODUCTION

(76) Inventors: Johnathan Goodwin, Wichita, KS (US); Uli Kruger, Aldgate (AU); Neil Young, Los Angeles, CA (US)

Correspondence Address: BUCHALTER NEMER, 18400 VON KARMAN AVE., SUITE 800, IRVINE, CA, 92612, US

(21) Appl. No.: 12/370,380

(22) Filed: Feb. 12, 2009

Related U.S. Application Data
(60) Provisional application No. 61/028,353, filed on Feb. 13, 2008.

(51) Int. Cl. B60W 10/04; F16H 3/74; B60W 10/24; B60W 20/00

(52) U.S. Cl. 180/65.265; 475/254; 180/65.21

(57) ABSTRACT

Hybrid-electric vehicle are described herein and comprises: an electric motor, at least one battery pack, at least one capacitor bank, at least one generator, at least one engine, and a controller, wherein the controller is coupled to the at least one battery pack, the at least one capacitor bank and the at least one engine. Power systems are also disclosed, wherein the power systems include: at least one battery pack, at least one capacitor bank, at least one generator, and a controller, wherein the controller is coupled to the at least one battery pack, the at least one capacitor bank and the at least one generator. In addition, modified gear boxes are disclosed that include: an epicyclic roller arrangement and a control mechanism coupled to an output shaft.

This Application is a United States Utility Application that claims priority to U.S. Provisional Application Ser. No. 61/028,353 filed on Feb. 13, 2008, which is incorporated herein in its entirety by reference.

### FIELD OF THE SUBJECT MATTER

The field of the subject matter described herein is hybrid electric motor vehicles, component design and related technologies.

### BACKGROUND

Electric and hybrid electric vehicles, both existing cars and concept cars, have gained popularity in recent years as a result of rising gasoline cost, longer commute times, traffic congestion and increased public awareness on the consequences of green-house gas emissions and the use of foreign oil.

The reality of domestic crude oil drilling is that there is not enough equipment or refineries to process enough recovered crude oil to meet our immediate demands. Any crude recovered won't be ready for public consumption for at least eight years. Two other options that are being used to bridge the gap between foreign oil importation, domestic oil production and new technologies are ethanol and compressed natural gas. Both fuels solve the problem of America's dependence on foreign sources of oil. Neither fuel solves the problems of greenhouse gas emissions and complete renewable energy sources.

Ethanol is produced in the US from corn or switchgrass, as opposed to sugar ethanol produced in South America, and is utilized as both a fuel additive and straight fuel source. While ethanol fuel is cleaner than gasoline, the process to produce ethanol is rife with greenhouse gas-producing sources, including ethanol-generating facilities that burn coal to transform corn to ethanol.

Compressed natural gas (CNG) is a fossil fuel source and found in abundance in the US. While it is a cleaner combustion fuel, it still produces greenhouse gases. The innovation surrounding CNG will be directed primarily to four things: recovery of CNG, gas station retrofitting to accept CNG, since the tanks needed to store this fuel source are larger, retooling of transportation production lines to produce engines that can accept CNG, and scrubbing exhaust streams of greenhouse gases.

The “holy grail” in the area of automobile development is to give the consumer unlimited car options, while at the same time significantly improving fuel efficiency, moving to zero emission engines and traveling long distances without charging, if the car is electric. Car buyers do not want to be forced to purchase small cars with little/no storage space, power or hauling capacity.

Developers are also utilizing new sources of power generation, such as solar and turbines, to provide power to new engines. Obviously, both of these power sources are renewable and do not rely on complex processes for recovery, refinement and production. Key innovations in this particular technology will improve the efficiency and size of solar panels and components, along with similar advancements in turbine development. These innovations are already taking place with solar and wind turbine power generation on a large scale.

Once the power is generated and backup power is stored, the next step is giving the car enthusiast a reason to get excited about driving these new cars. Most of this excitement comes from the ability to move quickly with power over different terrains without loss of performance.

Technology has come far enough along to make the concept of an “ideal vehicle” a reality for the typical consumer. The ideal vehicle is powered by an unlimited renewable source, such as wind, waves or sun. In the case of wind and waves—each of these sources can be utilized to produce the electricity used to charge up a battery in a vehicle. An ideal vehicle is whatever type of vehicle that car buyer wants to purchase, as mentioned earlier. If the consumer wants to purchase a large SUV, such as a Suburban or Hummer, the car should be hybrid-electric or electric, powerful and have a long-range of travel between charges. These cars should also be zero emission vehicles that are capable of powering a home or other facility, if necessary, as opposed to being a one-way consumer of power and electricity.

As researchers continue to develop new and improved engines, there are several areas that are focused on: performance, efficiency and ease of use. Performance can be measured by how a vehicle—whether it's a car, motorcycle or boat—responds under a “request” by the driver for more power. Whether a driver wants to accelerate quickly or tackle an incline at consistent speeds, performance is an important consideration when building and/or improving engines. Efficiency is related to performance, and is measured by how much of the stored energy is converted into kinetic energy and how much of it is lost as heat. Finally, the ease of use relates to whether the engine and related devices are easy to manufacture, easy to install and easy to maintain by a consumer. All of these component characteristics should be considered and balanced when designing, developing and building new engine technologies.

Electric vehicles, such as the Tesla Roadster from Tesla Motors, have certain advantages. They are considered “zero emission” vehicles because they produce no greenhouse gas. However, there are certain limitations associated with conventional electric vehicles. Most significantly, the range of an electric vehicle is limited by its battery capacity and the battery's long recharge time. A typical electric vehicle using a lead-acid battery has a range of less than 100 miles before a recharge is required. Advanced batteries such as nickel metal hydride (NiMH) and lithium-ion batteries have higher capacities, but are still incapable of being used for long-distance travel. Another drawback of an electric vehicle is its power source. While electric vehicles do not generate greenhouse gases, they rely on energy generated at power plants. Many of these power plants emit green-house gases, and much of the power generated at the power plants is wasted during the transmission from the power plants to the consumers.

The use of hybrid electric powertrains—a combination of an electric motor and an internal combustion engine—addresses the range limitation of electric vehicles; however, it doesn't address the issue of fuel consumption and greenhouse gas emissions. Conventional hybrid electric vehicles typically have a small gasoline engine and an electric motor. The electric motor, the gasoline engine, or a combination of both can be used to power the vehicle. Thus, when the battery is low on energy, the vehicle can still operate using the gasoline engine alone. Typically, traditional hybrid electric vehicles use regenerative braking to charge their batteries.

There are several drawbacks to conventional hybrid electric vehicles. First, a traditional hybrid electric vehicle has both a complete internal-combustion engine system (including an engine and a transmission) and an electric motor system (including a generator, a battery, and electric motors). Therefore, the weight of the vehicle is greatly increased as compared to an electric vehicle or a gasoline vehicle with a similar-sized gasoline engine. In addition, the manufacturing cost of the vehicle is increased due to the need to have both an internal combustion engine system and an electric motor system.

A problem common to both electric Vehicles and conventional hybrid electric vehicles is the weight and cost of the batteries. Both types of vehicles must carry a large and heavy battery pack. Furthermore, with each successive charge and recharge cycle, the capacity of the battery pack degrades. Typically, the battery pack of an electric or traditional hybrid electric vehicle must be replaced after a certain period of use, such as 100,000 miles.

Therefore, it would be ideal to create a hybrid-electric vehicle that has features solving all of the problems stated above: longer range, lighter weight, highly efficient power generation, little or no fossil fuels and a smaller battery pack.

### BRIEF DESCRIPTION OF THE FIGURES

FIG. 1 is a conceptual drawing of a contemplated hybrid electric vehicle;

FIG. 2 is a flow diagram illustrating the operation of a controller of a contemplated hybrid electric vehicle;

FIG. 3 is a conceptual diagram illustrating a contemplated hybrid electric vehicle; and

FIG. 4 is a conceptual diagram illustrating a fuel vaporizing system of a contemplated hybrid electric vehicle.

### SUMMARY OF THE SUBJECT MATTER

Hybrid-electric vehicle are described herein and comprises: an electric motor, at least one battery pack, at least one capacitor bank, at least one generator, at least one engine, and a controller, wherein the controller is coupled to the at least one battery pack, the at least one capacitor bank and the at least one engine.

Power systems are also disclosed, wherein the power systems include: at least one battery pack, at least one capacitor bank, at least one generator, and a controller, wherein the controller is coupled to the at least one battery pack, the at least one capacitor bank and the at least one generator.

In addition, modified gear boxes are disclosed that include: an epicyclic roller arrangement and a control mechanism coupled to an output shaft.

### DETAILED DESCRIPTION

Electric vehicles are described herein that have features solving all of the problems stated above: longer range, lighter weight, highly efficient power generation, little or no fossil fuels and a smaller battery pack.

Hybrid-electric vehicle are described herein and comprises: an electric motor, at least one battery pack, at least one capacitor bank, at least one generator, at least one engine, and a controller, wherein the controller is coupled to the at least one battery pack, the at least one capacitor bank and the at least one engine.

Power systems are also disclosed, wherein the power systems include: at least one battery pack, at least one capacitor bank, at least one generator, and a controller, wherein the controller is coupled to the at least one battery pack, the at least one capacitor bank and the at least one generator.

In addition, modified gear boxes are disclosed that include: an epicyclic roller arrangement and a control mechanism coupled to an output shaft.

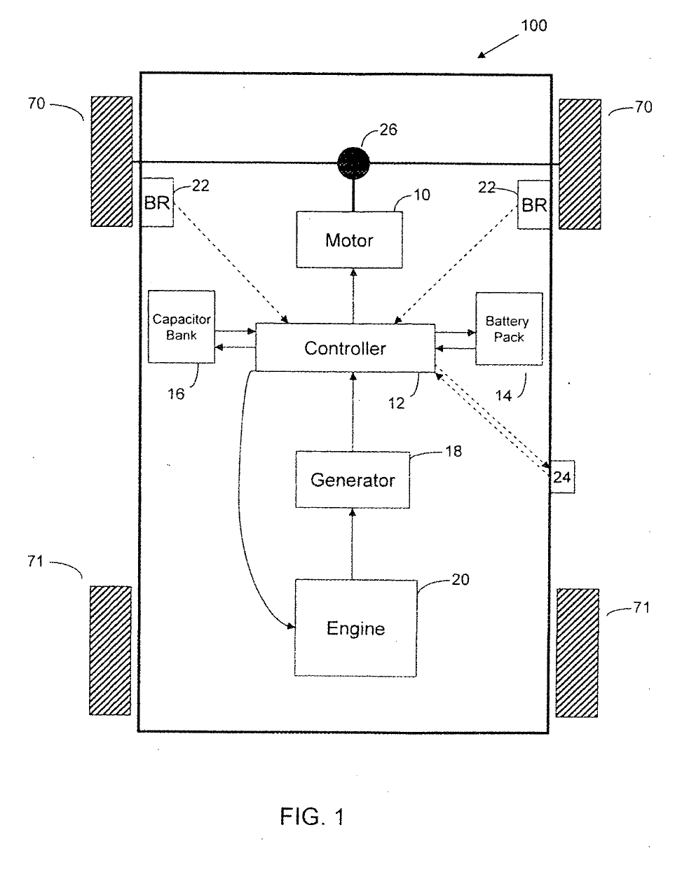

FIG. 1 is a conceptual diagram illustrating a contemplated hybrid electric vehicle. The vehicle 100 has two rear wheels 70 and two front wheels 71. The vehicle 100 further comprises: an electric motor 10, a controller 12, a battery pack 14; a capacitor bank 16, a generator 18, and an engine 20. The vehicle 100 also comprises other components commonly found in a motor vehicle that are not illustrated in FIG. 1. The electric motor 10 is mechanically connected to the rear wheels 70 through a rear differential 26. The rear differential 26 contains gears such that the motor 10 and rear wheels 70 form a gear ratio of approximately 4.5 to 1. This gear ratio of approximately 4.5 to 1 enables the vehicle 100 to be operated at up to 100 miles per hour. The engine 20 is mechanically connected to and drives the generator 18. The controller 12 is electrically connected to each of the motor 10, the battery pack 14, the capacitor bank 16, the generator 18, and the engine 20. In some embodiments, the capacitor bank could be built into a contemplated battery back or could be kept separate.

A contemplated electric motor 10 drives the front wheels 70 based on control signals from the controller 12. A contemplated controller 12 provides an electric current to the electric motor 10 and controls the speed of the vehicle by adjusting the level of electric current provided to the electric motor 10. For example, when the gas pedal (not illustrated) is depressed by an operator of the vehicle 100, the controller 12 increases the electrical current provided to the electric motor 10, and thus the electric motor 10 drives the front wheels 70 faster. A contemplated controller 12 can draw power from or provide power to each of the battery pack 14 and the capacitor bank 16. A contemplated controller 12 also controls the operation of the engine 20. A contemplated engine 20 provides mechanical power to a generator 18, and the generator 18 converts the mechanical power provided by the engine 20 into an electric current transmitted to the controller 12. In one embodiment, the generator 18 further comprises a 75 kW alternator.

A contemplated engine 20 can be, but is not limited to, any of the following: a gasoline internal combustion engine, a diesel engine, a bio-diesel engine, a turbine engine, a Wankel rotary engine, a Bourke engine, an ECTAN engine, an engine that uses E85 fuel, a flexible-fuel engine (an engine that operate on either gasoline or E85 fuel), a hydrogen-powered engine, an ethanol powered engine, a natural-gas powered engine, a jet-fuel turbine engine, a hydrogen fuel-cell engine, a modified diesel engine using vegetable oil as a fuel, a steam engine or a combination thereof. A contemplated engine 20 can also be an engine that runs on a new source of fuel or combination of fuels—such as a water-derived fuel created by using electricity and high frequency waves to bend the molecular structure of water, such that the water vapor is in a high-energy vapor state, or by using a high efficiency electrolysis process.

The engine may also use a catalytic igniter, such as those described in: U.S. Pat. No. 4,977,873, U.S. Pat. No. 5,109,817, U.S. Pat. No. 5,297,518 and U.S. Pat. No. 5,421,299. A contemplated catalytic igniter eliminates the use of any electrical ignition system altogether. A contemplated catalytic ignition source within the combustion igniter is enclosed in a custom-machined metal body, which forms a pre-chamber adjacent to the main combustion chamber. The body fits into existing spark plug or diesel injector ports, thus no machining to the engine is required. Ignition starts within the igniters pre-chamber. Surface ignition begins first as a fresh mixture of fuel contacts the ignition source during the compression stroke. Because of the reduced activation energy associated with the catalytic ignition source, this occurs at temperatures far below the normal gas-phase ignition temperature. Combustion products such as (CO, CHO, OH and hydrocarbons) and intermediate species then accumulate within the pre-chamber. After sufficient temperature is achieved, due to compression, multi-point homogeneous ignition results. The fuel mixture is then rapidly expelled through the nozzles at the bottom of the igniter. The nozzles cause the flame torch to swirl and cover the entire combustion chamber in an exceedingly short period of time, which enables the engine to run at ultra lean mixture levels at which ignition would be difficult to achieve with conventional sparkplugs.

In one embodiment, a rotary engine or Wankel rotary engine is utilized, as described earlier. The rotary has a number of advantages over a reciprocating piston engine, including a high power to weight ratio; its virtually vibration free; it tolerates high RPM; there are no reciprocating components such as valves, conrods, etc.; there are low parasitic losses due to lack of component friction; there are only two moving parts per rotor; there is a long combustion cycle; there are unobstructed inlet and exhaust ports; there is a low tendency to pre-ignition; it is compact and has a simple construction; and there's a low BSFC (brake specific fuel consumption) at fixed low RPM.

However, the rotary engine has one advantage that makes it most suitable for sport cars—its smooth power delivery and total lack of vibration. In a conventional engine, the pistons have to be accelerated to speeds of many meters (feet)/second in between dead stops at the top and bottom, which happens thousands of times per minute. This fact limits the maximum amount of revolutions the engine can withstand before catastrophic failure occurs. The limiting factor in this conventional engine is the maximum piston speed. In the rotary, the rotor continuously revolves inside the housing. There are no side forces, causing additional friction and the moment of inertia of the internal moving parts is continuous rather than cyclical. A contemplated rotary engine can easily withstand 12000 revolutions/minute without any problems or complications.

In contemplated embodiments, a rotary engine can be utilized under operating conditions that do not expose its inherent disadvantages, such as high fuel consumption. This optimization is accomplished by picking the lowest point on the BSFC curve and running the engine at those conditions only. There is no idle or high RPM operation cycle that could compromise emissions or fuel consumption. In addition, rapid load changes are avoided, which enables “tunability” of the fuel delivery system to super lean conditions, specifically to one fixed load and RPM point, by utilizing a liquid to vapor phase change fuel system, which is discussed herein, later followed by a high pressure direct injection compression ignition (diesel) system. The result is an extremely light and compact power generation module with exceptionally low specific fuel consumption characteristics, far superior then anything that is available now.

In some embodiments, contemplated rotary engines may be improved by direct injection into the combustion chamber, as well as removal of the throttle plate, which eliminates pumping losses. In addition, with the inherently low parasitic friction losses of the rotary, the modification gives a substantially efficient yet ultra compact engine. This method was unsuccessfully use by Mercedes Benz C111 concept rotary concept car in 1969 (http://www.pistonheads.com/doc.asp?c=103&i=6730), but it did no succeed because the microcontrollers used to control the injection timing were not fast enough.

In some embodiments, Wankel-type rotary engines may be designed to be operated with hydrogen fuel. Using hydrogen may address some of the inherent disadvantages of the rotary engine, such a incomplete combustion due to the irregular combustion chamber geometry. Hydrogen burns with an extremely fast flame front, thus eliminating combustion dead spots. One contemplated engine is a Mazda 13B engine, which is converted to single rotor. The engine is then directly coupled to a 75 kw DC alternator, which is run at a constant speed of 4000 rpm. The governor/load control is accomplished by an electronically-operated throttle plate. For gas (natural gas/hydrogen) embodiments, a contemplated engine is set up with a vortex mixer in the air intake fed by an Impco E-type converter. The second stage of the converter can be operated with a constant pressure of 3 kpa or the first stage with 0.6 mpa, as long as there is a constant flow rate. This contemplated engine only has to support about 40 kW at full load with the rest of the energy coming from a contemplated heat recovery system.

In addition to other engine types disclosed herein, a radial inflow laminar flow blade engine may be used where both the compressor and turbine stages are comprised of a plurality of axially spaced discs. This type of turbine engine setup has substantial advantages over the conventional design, comprising of “Garret” type compressor and turbine wheels. The Garret type turbine engine will only run at it's maximum efficiency at very narrow power range (between 95 and 100% load). It also has to operate at very high output speed. The turbine wheels can only operate below a maximum angular circumference velocity limited by the maximum airspeed at which the blades will still function. Power output is therefore achieved with higher rpm and smaller diameter blades.

For example, the 130 HP Garret turbine engine has a shaft speed of 60000 rpm. Mechanically reducing this speed to a required output speed of about 5000 rpm causes additional friction losses as well as an increase in weight and complexity. Both the narrow power band as well as high rpm and low torque characteristic have so far made the turbine engine impractical to use as a car engine. The laminar flow multi-blade disc engine; however, may be designed to match it's maximum torque at revolutions compatible with both conventional automotive drive trains as well as electric alternators, which can result in an engine with common single shaft construction with only one main moving part with no friction losses or surface wear. The laminar flow engine will operate efficiently over a wide power-band comparable to that of a conventional 4-stroke piston engine.

In some contemplated embodiments, a contemplated capacitor bank 16 is composed of or comprises a bank of ultra-capacitors, which are also known as super capacitors or electrochemical double layer capacitors. As mentioned herein, contemplated capacitor banks can charge the at least one battery pack by utilizing a trickle charge.

In operation, a contemplated engine 20 is a high-efficiency engine that provides a constant amount of mechanical power to the generator 18. The engine of a conventional gasoline-powered automobile or a conventional hybrid electric vehicle varies its power output, in terms of revolutions-per-minute (RPM), in response to different driving conditions. Thus, a conventional gasoline engine often operates at a suboptimal RPM in terms of the power to fuel consumption ratio. By contrast, the engine 20 of an improved hybrid electric vehicle 100 operates at a constant RPM tuned to the optimal point of the engine 20—where the ratio between power production and fuel consumption is maximized.

A contemplated generator or combination of generators is one of the key building blocks to this hybrid-electric system for powering vehicles, and in this system, the generator or combination of generators may comprise any suitable efficient component or system. Contemplated generators may comprise various turbines, such as Tesla turbines, rotary devices, tuned single rpm version of a rotary device or a combination thereof.

A contemplated engine 20 directs all of its mechanical power into the generator 18, and the generator 18 converts that mechanical power into an electrical current. This method of electricity generation is significantly more efficient than the method of using regenerative braking found in conventional hybrid electric vehicles, where a significant portion of mechanical power is wasted and irrecoverable. Therefore, during operation, the engine 20 and generator 18 together produces a highly efficient source of electrical current to the controller 12.

Since the engine 20 is tuned to its optimal RPM, the generator 18 is able to supply a high-level of current to the controller 12. However, the charging rate of the battery pack 14 is relatively slow. Thus, if the electrical current from the generator 18 is used to directly charge the battery pack 14, much of the energy generated by the generator 18 would be wasted because the charging rate is limited by the battery pack 14. Thus, the controller 12 of the vehicle uses the electric current from the generator 18 to charge the capacitor bank 16, which charges almost instantaneously. After the capacitor bank 16 becomes fully charged, the controller 12 shuts off the engine 20 and trickle charges the battery pack 14 using the electric energy stored in the capacitor bank 16.

During operation, a contemplated controller 12 draws power from the battery pack 14 to drive the vehicle 100. The controller 12 also monitors the energy level of the battery pack 14 periodically. When the energy level of the battery pack 14 falls below a predetermined threshold, the controller 12 transmits a control signal to the engine 20 to turn on the engine 20. The engine 20 then begins operation and generates an electrical current (through the generator 18) and provides that electrical current to the controller 12. The controller 12 uses the electrical current to charge both the capacitor bank 16 and the battery pack 14. When the capacitor bank 16 is fully charged, the controller 12 transmits another control signal to the engine 20 to turn off the engine 20. After the engine 20 is turned off, the capacitor bank 16 continues to charge the battery pack 14 through trickle charging. Accordingly, the engine 20 of the vehicle 100 operates for only a short period of time, or an extended period of time as required under extreme load and duration of extreme load, and almost all of the electrical energy generated by the engine 20 is fully captured. Therefore, the vehicle 100 can operate efficiently using little fuel.

In most operation conditions, a contemplated battery pack 14 provides sufficient power to maintain the operation of the vehicle 100. However, in situations where the vehicle 100 requires a short burst of power (e.g., during sudden acceleration or steep hill climbing), the controller 12 can draw power from the capacitor bank 16 or turn on the engine 20 for a short period of time to supplement the power from the battery pack 14. Contemplated controllers charge the battery pack and the capacitor as required.

In some embodiments, a contemplated modified gear box can be utilized that converts and regulates power directly from the source generator to the electric motor, which solves many of the issues with power and propulsion in electric vehicles. One important consideration is that the engine, the alternator and the electric drive motor operate within their optimum power bands at all times, which will result in optimal overall system efficiency. The key to this is the modified gear box, which may be or comprise an infinitely variable gearbox, with minimal internal transmission losses. One contemplated gear box comprises an epicyclic roller arrangement with a control mechanism that feeds the speed control force back into the output shaft with no losses. Contemplated embodiments may comprise more than one modified gear box—such as one between the engine and the alternator and one between the drive motor(s) and the wheels. These multiple gear boxes will allow for the maximization of the efficiency band of all components in the desired optimal range.

In addition, this contemplated overall design solves the inherent problem related to the reliance on batteries as the primary source of power. Batteries are not renewable, do not stay charged for longer than 200-300 miles of normal use, and are not environmentally-friendly. Specifically, the electric gearbox is an electro-mechanical device which uses a rotational-mechanical aspect to deliver an infinite amount of gears, rather than the usual 3 to 6 levels, which results in a constantly changing amount of power to the wheels, while the source remains constant at its most fuel efficient rpm (if the rotary/turbine arrangement is in use). It also replaces the electric motor controller, which is quite expensive. Contemplated gear boxes may be modified from existing gear boxes or may be custom designed and/or built for the vehicle as needed.

In one embodiment, the vehicle 100 further comprises a regenerative braking system 22. The regenerative braking system 22 connects to the brakes on the front wheels 70, and provides an electric current to the controller 12 during the operation of the vehicle 100. In some embodiments, the vehicle 100 comprises a regenerative shock absorption system (not shown), which can be used in conjunction with or as an alternative to regenerative braking. A regenerative shock absorption system is a type of shock absorption system that converts parasitic intermittent linear motion and vibration into useful energy, such as electricity. This type of system was disclosed in U.S. Pat. No. 6,952,060, which is incorporated herein in its entirety by reference. Conventional shock absorbers simply dissipate this energy as heat. In some other embodiments, heat generated from dynamic braking systems and conventional shock absorption systems may be “recycled” and utilized to produce energy for the vehicle.

In another embodiment, the vehicle 100 further comprises an external interface 24 that is electrically connected to the controller 12. This allows the vehicle 100 to be used as a “plug-in hybrid”—where the vehicle owner can recharge the battery pack 14 and capacitor bank 16 when the vehicle 100 is not in operation. An owner of the vehicle 100 can charge the battery pack 14 during times when the vehicle is not in use, such as during night-time. The owner can then operate the vehicle for a distance (e.g., about 100 miles) before the battery is nearly depleted. The controller 12 would then turn on the engine 20 periodically to charge the capacitor bank 16, which in turn trickle charges the battery pack 14. Accordingly, vehicle 100 can be driven for a long distance using very little fuel.

Alternatively, the external interface 24 can also be used to deliver a source of electrical power from the battery 14 or directly from the generator 18, in both cases via the controller 12. Thus, the vehicle 100 can be used as an emergency generator, or can be used to supply power back to the power-grid when the vehicle 100 is not in operation. If the water-derived fuel is used, the car can be left on overnight to power the house and charge the grid while the car is indoors, without risk of air contamination, since the emissions from the water fuel are not damaging to the environment in an enclosed garage.

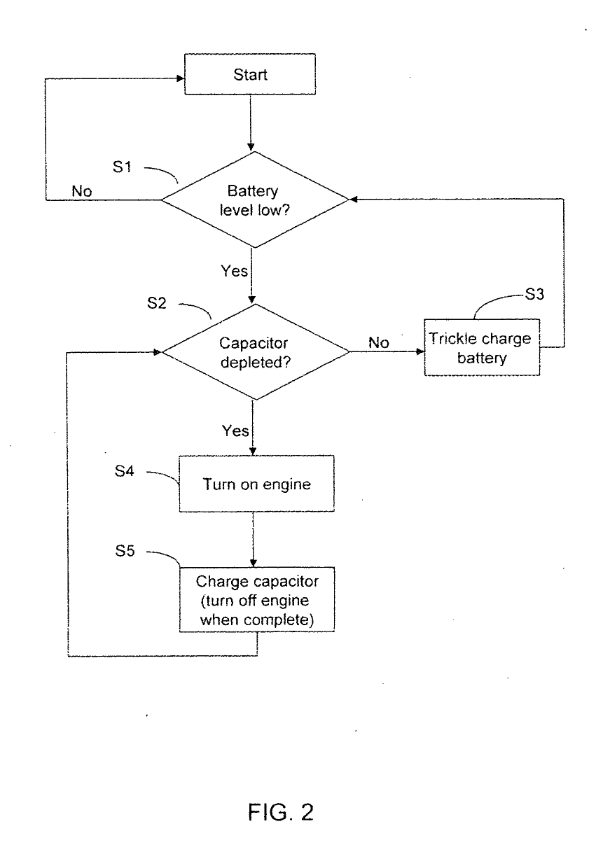

FIG. 2 is a flow chart illustrating the operation of the controller 12. In step S1, the controller 12 periodically checks the energy level of the battery pack 14. If the charge level of the battery pack 14 is above a predetermined threshold, no action is taken. If the charge level of the battery pack 14 is below the threshold, the controller 12 checks the charge level of the capacitor bank 16 (step S2). If the charge of the capacitor bank 16 is not depleted, the controller 12 draws a current from the capacitor bank 16 to trickle charge the battery pack 14 (step S3). If the capacitor bank 16 is depleted, the controller 12 transmits a control signal to the engine 20 to turn on the engine 20 (step S4). Next, the controller 12 uses the electrical current generated by the engine 20 and generator 18 to charge the capacitor bank 16 (step S5). When the capacitor bank 16 is fully charged, the controller 12 transmits a second signal to the engine 20 to turn off the engine 20 (step S5). The controller 12 then uses the capacitor bank 16 to charge the battery pack (steps S2 and S3).

In one embodiment, the controller 12 further comprises a microcomputer programmed to perform the functions described above. The controller may also be analog-based or based on any suitable technology.

There are several advantages of the vehicle 100 described above. First, the vehicle is more efficient compared to a conventional hybrid electric vehicle because the engine 20 operates only at its optimal point and almost all energy produced by the engine 20 is captured. Second, as compared to a conventional hybrid electric vehicle, the weight and cost of production is reduced for the vehicle 100 because there is no need to install a complete internal combustion engine system—components like the transmission for the internal combustion engine are no longer necessary. As compared to an electric-only vehicle, the range of the vehicle 100 is not limited to its battery capacity. Since the range of the vehicle 100 is not limited by the capacity of the battery pack 14, the size and weight of the battery pack 14 can be made smaller than the battery pack of a conventional electric-only vehicle.

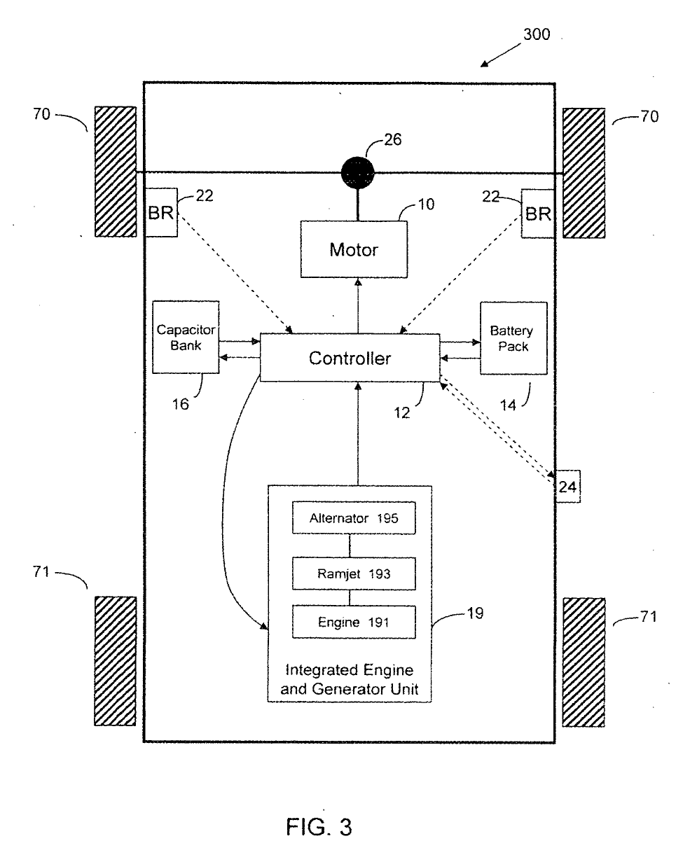

FIG. 3 illustrates a contemplated hybrid electric vehicle 300, which differs from the hybrid electric vehicle 100 illustrated in FIG. 1 in having an integrated engine and generator unit 19.

The integrated engine and generator unit 19 comprises a liquid-fueled or gaseous-fueled engine 191, a Ramjet 193, and an alternator 195. The engine 191 generates heat and supplies the heat to the Ramjet 193. The Ramjet 193 converts the heat into mechanical power through a Tesla-style steam turbine, and the alternator 195 converts the mechanical power produced by the Ramjet 193 into an electrical current. In one embodiment, the alternator 195 is a 75 kW alternator. The integrated engine and generator unit 19 is capable of reaching 90% efficiency in converting energy from fuel to electricity. The remainder of the vehicle 300 operates in the same fashion as the vehicle 100 discussed above.

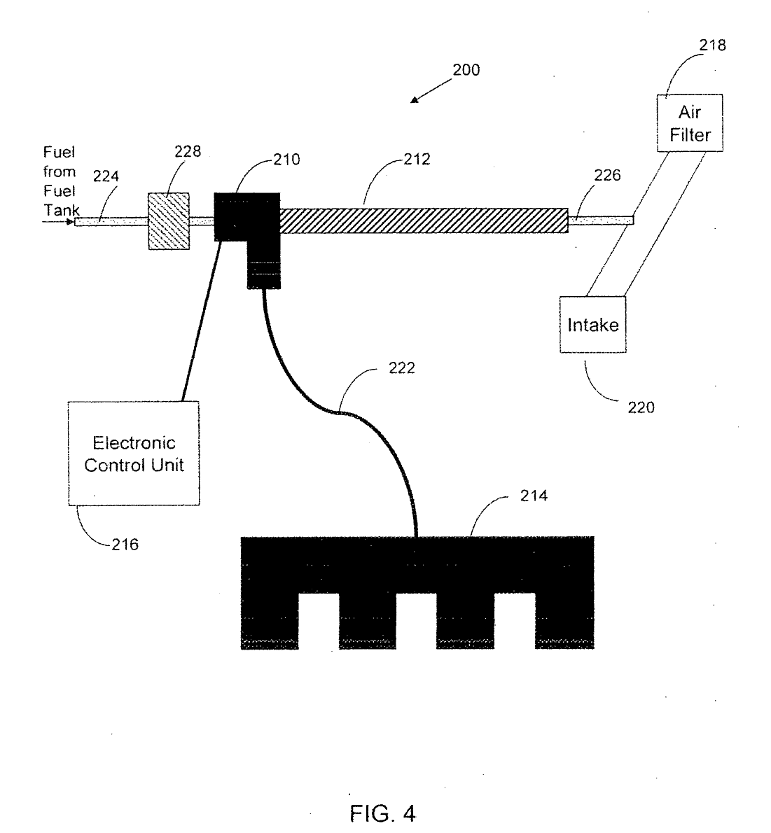

FIG. 4 is a conceptual diagram of a fuel vaporizer system 200 of an E85 engine (or flexible-fuel engine) for a contemplated hybrid electric vehicle. Often, engines that use E85 fuel (a blend of ethanol and gasoline) do not burn the E85 fuel cleanly. The fuel vaporizer system 200 improves the efficiency of an engine by vaporizing the fuel and oxygenating the fuel before it enters the intake 220 of the engine.

The fuel vaporizer system 200 comprises an electronic control unit (ECU) 216, a heating valve 210, and a heating chamber 212. The ECU 216 takes readings from various fuel sensors, exhaust temperature sensor, and coolant temperature sensor (all not shown) to adjust the heating valve 210. The heating valve 210 is connected to the exhaust manifold 214 via a heat conductor 222. The heat conductor 222 conducts heat from the exhaust manifold 214 to the heating valve 210 through a flow of heated air. The heating valve 210 then conducts the heat received from the exhaust manifold 214 to a heating chamber 212. Liquid fuel flows from the fuel tank (not illustrated) via the fuel line 224 into the fuel injector 228. The fuel injector 228 regulates the flow of the fuel and injects a certain amount of fuel into the heating chamber 212 for each engine cycle. The heating chamber 212 provides an enlarged surface area to promote the vaporization of the fuel injected from the fuel injector 228. In one embodiment, the heating chamber 212 is 12 inches long such that it provides sufficient surface area to adequately vaporize the fuel from the fuel injector 228. During operation, the ECU 216 controls the heating valve 210, allowing an amount of heat to be conducted from the exhaust manifold 214, through the heat conductor 222 and heating valve 210, to the heating chamber 212. The heating chamber 212 then heats the fuel injected by the fuel injector 228 sufficiently to vaporize the fuel, and injects the vaporized fuel via another portion of the fuel line 226 into the path between the air filter 218 and intake 220. The vaporized fuel is mixed with the air from the air filter 218 such that it is fully oxygenated before it reaches the intake 220 of the engine. The ECU 216 uses readings from various sensors to regulate the heating valve 210 such that the temperature of the heating changer 212 is kept above the vaporization point of the fuel but below the flashing point of the fuel.

Because the fuel is completely vaporized and oxygenated before it reaches the engine chamber, an engine with a heat vaporizer system 200 burns its fuel more efficiently and cleanly than a conventional engine without such a system. In addition to improving fuel efficiency, the fuel vaporizer systems 200 also ensures that the fuel is burned completely and eliminates exhaust emissions that are harmful to the environment—such as carbon monoxide and carbon soot.

The principles illustrated in the fuel vaporizer system of 200 of FIG. 3 are also applicable to any engine that uses a liquid fuel—such as gasoline internal-combustion engine, a diesel internal combustion engine, or a jet-fuel turbine engine.

In another embodiment, a heat recovery system can be utilized that is characterized as a stand-alone vapor fuel system. In many embodiments, the system provides a 30% fuel savings immediately. A contemplated vapor fuel system is especially ideal for a rotary engine system in the vehicle. In other contemplated embodiments, separate biodiesel injectors can be coupled to the vapor fuel system that will allow it to run in full diesel mode. In these embodiments, the engine can run on diesel fuel, biodiesel fuel, lipodiesel fuel, gasoline, ethanol, propane, compressed natural gas (CNG) or any other suitable fuel source.

It should be appreciated that various modifications, adaptations, and alternative embodiments thereof may be made within the scope and spirit of the present subject matter. For example, a contemplated hybrid electric vehicle could be front-wheel driven, four-wheel driven, driven by any other combination of the wheels, or be driven by multiple electric motors. A contemplated hybrid electric vehicle could also use an advanced lithium-ion battery that charges very rapidly such that it does not need to have both a battery pack and a capacitor bank. Further, the fuel vaporizing system can be used in a conventional internal-combustion vehicle or a conventional hybrid electric vehicle.

Thus, specific embodiments and applications of hybrid electric vehicles and methods of production have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A hybrid-electric vehicle, comprising:
an electric motor,
at least one battery pack,
at least one capacitor bank,
at least one generator,
at least one engine, and
a controller, wherein the controller is coupled to the at least one battery pack, the at least one capacitor bank and the at least one engine.

2. The hybrid-electric vehicle of claim 1, wherein the at least one engine comprises a gasoline internal combustion engine, a diesel engine, a bio-diesel engine, a turbine engine, a Wankel rotary engine, a Bourke engine, an ECTAN engine, an E85 fuel engine, a flexible-fuel engine, a hydrogen-powered engine, an ethanol-powered engine, a natural-gas powered engine, a jet-fuel turbine engine, a hydrogen fuel-cell engine, a modified diesel engine, a steam engine or a combination thereof.

3. The hybrid-electric vehicle of claim 1, wherein the at least one capacitor bank comprises at least one ultracapacitor.

4. The hybrid-electric vehicle of claim 1, further comprising a regenerative braking device, a regenerative shock absorption device or a combination thereof.

5. The hybrid-electric vehicle of claim 1, further comprising an external interface.

6. The hybrid-electric vehicle of claim 5, wherein the external interface comprises an emergency generator.

7. The hybrid-electric vehicle of claim 5, wherein the external interface comprises a charging mechanism.

8. The hybrid-electric vehicle of claim 7, wherein the charging mechanism is coupled to the at least one battery pack.

9. The hybrid-electric vehicle of claim 1, wherein the at least one generator comprises at least one turbine, at least one rotary device, a tuned single rpm version of a rotary device or a combination thereof.

10. The hybrid-electric vehicle of claim 1, wherein the at least one capacitor bank charges the at least one battery pack through a trickle charge.

11. The hybrid-electric vehicle of claim 1, wherein the engine are operated utilizing gasoline, diesel fuel, biofuel, lipofuel, natural gas, compressed natural gas, hydrogen fuel, water-derived fuel, ethanol, flex fuel, jet fuel or a combination thereof.

12. The hybrid-electric vehicle of claim 1, further comprises a catalytic igniter.

13. A power system, comprising:
at least one battery pack,
at least one capacitor bank,
at least one generator, and
a controller, wherein the controller is coupled to the at least one battery pack, the at least one capacitor bank and the at least one generator.

14. The power system of claim 13, further comprising at least one modified gear box.

15. The power system of claim 13, wherein the at least one capacitor bank comprises at least one ultracapacitor.

16. The power system of claim 13, wherein the at least one capacitor bank charges the at least one battery pack through a trickle charge.

17. The power system of claim 13, wherein the power system is coupled to at least one engine.

18. The power system of claim 17, wherein the at least one engine comprises a gasoline internal combustion engine, a diesel engine, a bio-diesel engine, a turbine engine, a Wankel rotary engine, a Bourke engine, an ECTAN engine, an E85 fuel engine, a flexible-fuel engine, a hydrogen-powered engine, an ethanol-powered engine, a natural-gas powered engine, a jet-fuel turbine engine, a hydrogen fuel-cell engine, a modified diesel engine, a steam engine or a combination thereof.

19. A transportation vehicle comprising the power system of claim 13.

20. The transportation vehicle of claim 19, wherein the vehicle comprises a car, truck, sport-utility vehicle, boat, motorcycle or a passenger vehicle.

21. A modified gear box, comprising:
an epicyclic roller arrangement, and
a control mechanism coupled to an output shaft.

22. A power system comprising at least one modified gear box of claim 21.

23. A transportation vehicle comprising at least one modified gear box of claim 21.

24. The transportation vehicle of claim 23, wherein the vehicle comprises a car, truck, sport-utility vehicle, boat, motorcycle or a passenger vehicle.
